(19) United States
(12) Patent Application Publication
(10) Pub. No.: US 2008/0111953 A1
(43) Pub. Date: May 15, 2008

(54) ELECTRON EMISSION DEVICE, LIGHT EMISSION DEVICE, AND DISPLAY DEVICE

(76) Inventors: Sang-Ho Jeon, Yongin-si (KR); Sang-Jo Lee, Yongin-si (KR); Su-Bong Hong, Yongin-si (KR); Jin-Hui Cho, Yongin-si (KR); Sam-Il Han, Yongin-si (KR)

Correspondence Address: CHRISTIE, PARKER & HALE, LLP, PO BOX 7068, PASADENA, CA, 91109-7068, US

(21) Appl. No.: 11/835,113

(22) Filed: Aug. 7, 2007

(30) Foreign Application Priority Data
Nov. 14, 2006 (KR) 10-2006-0112213

(51) Int. Cl. G02F 1/1333; H01J 1/62

(52) U.S. Cl. 349/84; 313/483

(57) ABSTRACT

An electron emission device and a display device having the electron emission device are provided. The electron emission device includes a plurality of driving electrodes located on a substrate and a plurality of electron emission regions electrically coupled to the driving electrodes. Each of the driving electrodes includes a first metal layer, a second metal layer, and a third metal layer. Here, the following condition is satisfied:

T3/T1≧1.0,

where T1 is a thickness of the first metal layer and T3 is a thickness of the third metal layer.

### CROSS-REFERENCE TO RELATED APPLICATION

This application claims priority to and the benefit of Korean Patent Application No. 10-2006-0112213, filed on Nov. 14, 2006, in the Korean Intellectual Property Office, the entire content of which is incorporated herein by reference.

### BACKGROUND OF THE INVENTION

(a) Field of the Invention

The present invention relates to a light emission device that can protect an internal structure thereof from being damaged by arcing. The present invention also relates to a display device using the light emission device as a light source.

(b) Description of Related Art

Generally, electron emission elements are classified into those using hot cathodes as an electron emission source, and those using cold cathodes as the electron emission source.

There are several types of cold cathode electron emission elements, including field emitter array (FEA) type electron emission elements, surface conduction emitter (SCE) type electron emission elements, metal-insulator-metal (MIM) type electron emission elements, and metal-insulator-semiconductor (MIS) type electron emission elements.

The FEA type electron emission element includes electron emission regions, and driving electrodes (e.g., cathode and gate electrodes). The electron emission regions are formed of a material having a relatively low work function and/or a relatively large aspect ratio, such as a molybdenum-based (Mo-based) material, a silicon-based (Si-based) material, and/or a carbon-based material, which can emit electrons when an electric field is formed around the electron emission regions under a vacuum atmosphere. In one embodiment, when the Mo-based material and/or the Si-based material is used for the electron emission regions, the electron emission regions are formed into sharp-tip structures. The carbon-based material may be carbon nanotubes, graphite, and/or diamond-like carbon.

A plurality of the electron emission elements are arrayed on a first substrate to constitute an electron emission device. The electron emission device is combined with a second substrate, on which a light emission unit having phosphor layers and an anode electrode is formed, to constitute a light emission device.

In addition to functioning as a display device, the light emission device with the above described structure may function as a light source for a non-self-emissive display device. A liquid crystal display (LCD) is a well known example of a non-self-emissive typical type display device.

The liquid crystal display includes a display panel having a liquid crystal layer and a light emission device for emitting light to the display panel. The display panel is supplied with light from the light emission device and selectively transmits or blocks the light by utilizing the liquid crystal layer.

Recently, a light emission device (e.g. a field emission type light emission device or an electron emission type light emission device) has been proposed to substitute for a cold cathode fluorescent lamp (CCFL) light emission device that is a linear light source and a light emitting diode (LED) type light emission device that is a point light source. The field emission type light emission device (or electron emission type light emission device) is a surface (or area) light source that can emit light by exciting a phosphor layer using electrons emitted from electron emission regions.

When compared with the CCFL type light emission device and the LED type light emission device, the field emission type light emission device has relatively lower power consumption, can enlarge a size of the display, and does not require a variety of optical members.

In a typical light emission device, the driving electrodes (e.g., the cathode electrodes and/or the gate electrodes) are applied with driving voltages required for driving the light emission device. In order to prevent the driving voltages for driving the light emission device from leaking (or to reduce a voltage leakage of the driving voltages), the driving electrodes should have a relatively low resistance.

### SUMMARY OF THE INVENTION

An aspect of an embodiment of the present invention is directed to an electron emission device in which a resistance of driving electrodes is improved and/or a variation of the resistance of the driving electrodes, after a high temperature thermal process is performed, is reduced (or minimized). Other aspects of embodiments of the present invention are directed to a light emission device and/or a display device using the electron emission device.

In an exemplary embodiment of the present invention, an electron emission device includes a substrate; a plurality of driving electrodes on the substrate; and a plurality of electron emission regions electrically coupled to the driving electrodes. Each of the driving electrodes includes a first metal layer, a second metal layer, and a third metal layer, which are successively layered, and a following condition is satisfied:

T3/T1≧1.0,

where T1 is a thickness of the first metal layer and T3 is a thickness of the third metal layer

The first metal layer may be formed of the same material as that of the third metal layer. The second metal layer may be formed of a material selected from the group consisting of aluminum, copper, gold, and combinations thereof. The first metal layer may be formed of a material selected from the group consisting chrome, molybdenum, molybdenum alloy, and combinations thereof.

The driving electrodes may be cathode electrodes and/or gate electrodes. The electron emission device may further include a focusing electrode located above the cathode and gate electrodes and insulated from the cathode and gate electrodes.

In another exemplary embodiment of the present invention, a light emission device includes a first substrate; a second substrate opposing the first substrate; an electron emission unit on the first substrate; and a light emission unit on the second substrate. The electron emission unit includes a plurality of driving electrodes on the first substrate. Each of the driving electrodes includes a first metal layer, a second metal layer, and a third metal layer, which are successively layered, and a following condition is satisfied:

T3/T1≧1.0,

where T1 is a thickness of the first metal layer and T3 is a thickness of the third metal layer.

In another exemplary embodiment of the present invention, a display device utilizes the above-defined light emission device as a light source and includes a display panel for displaying an image by receiving light from the light emission device.

### BRIEF DESCRIPTION OF THE DRAWINGS

FIG. 1 is a partial exploded perspective view of a light emission device according to a first exemplary embodiment of the present invention.

FIG. 2 is a cross-sectional schematic view taken along line II-II of FIG. 1.

FIG. 3 is a graph illustrating test results of an embodiment of the present invention and a comparative example.

FIG. 4 is a partial exploded perspective view of a light emission device according to a second exemplary embodiment of the present invention.

FIG. 5 is an exploded perspective schematic view of a display device using the light emission device of FIG. 4 as a light source.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Hereinafter, like reference numerals refer to like elements.

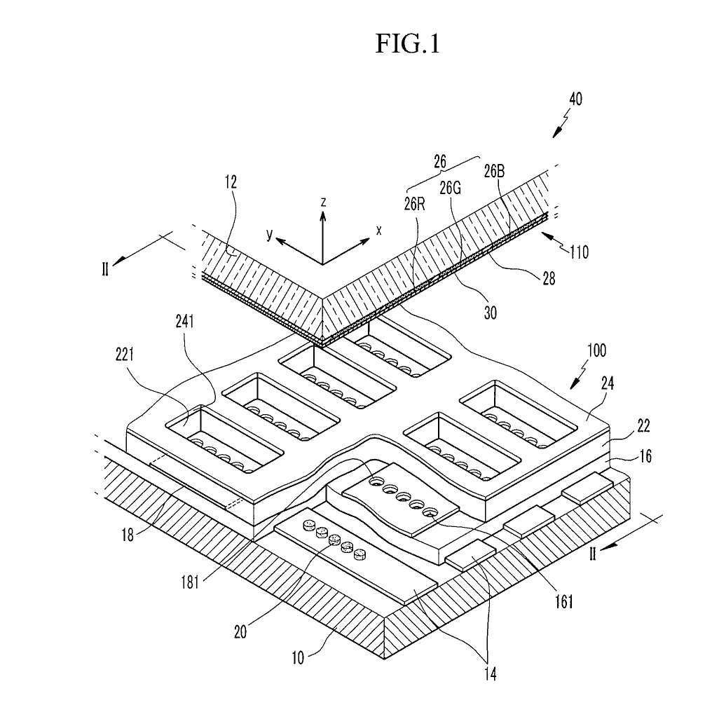

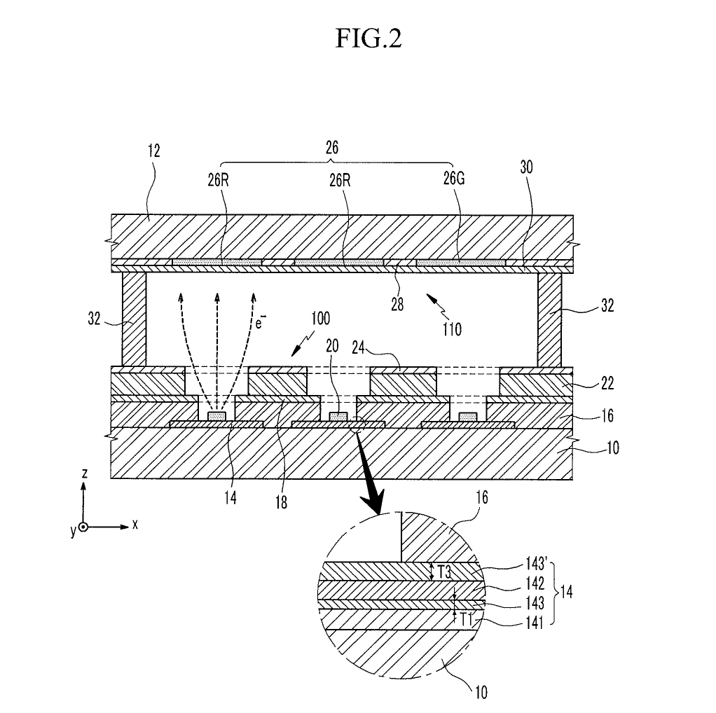

FIG. 1 is a partial exploded perspective view of a light emission device according to a first exemplary embodiment of the present invention, and FIG. 2 is a cross-sectional schematic view taken along line II-II of FIG. 2.

Referring to FIGS. 1 and 2, the light emission device includes a first substrate 10 and a second substrate 12 opposing the first substrate in a substantially parallel manner and with a gap (that may be predetermined) therebetween. A sealing member is provided between the first and second substrates 10 and 12 along edge portions thereof to seal the first and second substrates 10 and 12 together to thus form a vacuum vessel. The interior of the vacuum vessel is kept to a degree of vacuum of about 10⁻⁶ Torr.

An electron emission unit 100, including an array of electron emission elements, is provided on an inner surface (or a surface) of the first substrate 10 facing the second substrate 12. A light emission unit 110 having a phosphor layer and an anode electrode is provided on an inner surface (or a surface) of the second substrate 12 facing the first substrate 10.

The first substrate 10 on which the electron emission unit 100 is provided is combined with the second substrate 12 on which the light emission unit 110 is provided to form the light emission device.

The above described vacuum vessel may be applied to an electron emission device having FEA type electron emission elements, SCE type electron emission elements, MIM type electron emission elements, or MIS type electron emission elements. A light emission device having the FEA type electron emission elements will be described in more detail by way of example, but the present invention is not thereby limited.

Cathode electrodes 14 are formed on the first substrate 10 in a stripe pattern extending in a first direction (y-axis in FIG. 1).

An insulation layer 16 is located on the first substrate 10 while covering the cathode electrodes 14, and gate electrodes 18 are located on the insulation layer 16 in a stripe pattern extending in a second direction (x-axis in FIG. 1) crossing (or perpendicular to) the first direction to thereby cross (or intersect) the cathode electrodes 14.

As such, a plurality of crossing (or intersecting) regions are formed between the cathode and gate electrodes 14 and 18, and each of the crossing (or intersecting) regions may define a single unit pixel. Electron emission regions 20 are located on the cathode electrodes 14 at each unit pixel.

The electron emission regions 20 are formed of a material for emitting electrons when an electric field is applied thereto under a vacuum atmosphere, such as a carbon-based material and/or a nanometer-sized material. For example, the electron emission regions 20 may be formed of carbon nanotubes, graphite, graphite nanofibers, diamonds, diamond-like carbon, fullerene (C₆₀), silicon nanowires, or combinations thereof. Alternatively, the electron emission regions may be formed in sharp-tip structures using a Si-based material and/or a Mo-based material.

First openings 161 and second openings 181 corresponding to the respective electron emission region 20 are respectively formed in the first insulation layer 16 and the gate electrodes 18 to expose the electron emission regions 20 on the first substrate 10. That is, the electron emission regions 20 are formed on the cathode electrodes 14 and in the respective first and second openings 161 and 181 of the first insulation layer 16 and gate electrodes 18. In this exemplary embodiment, the first and second openings 161 and 181 are formed to have a circular shape. However, the present invention is not limited to this shape configuration.

To form the electron emission regions for backside emission (or rear light emission), the cathode electrodes 14 according to one embodiment of the invention are formed of indium tin oxide (ITO). Also, in one embodiment, to reduce the overall resistance of the cathode electrodes 14, one or more sub-electrodes formed of aluminum are arranged on the respective cathode electrodes 14.

However, the aluminum used for improving the resistance may experience a hillock phenomenon where a surface thereof becomes uneven during a high temperature thermal process, thereby increasing the resistance and reacting with the ITO electrodes.

In the present exemplary embodiment, each of the cathode electrodes 14 is formed in a multi-layer structure having an ITO electrode 141 and metal layers formed on the ITO electrode 141. That is, the cathode electrode 14 includes first, second, and third metal layers 143, 142, and 143′ that are stacked on the first substrate.

The first metal layer 143 is formed to contact the ITO electrode 141 formed on the first substrate 1 0. The first metal layer 143 functions to protect the second metal layer 142 that is formed thereon. That is, the first metal layer 143 is formed between the second metal layer 142 and the ITO electrode 141 to prevent (or protect) the second metal layer 142 from reacting with the ITO electrode 141 at a high temperature environment. The first metal layer 143 may be formed of chrome (Cr) so that it can be formed by an etching solution that is different from that used for forming the second metal layer 142. However, the present invention is not limited to this configuration. For example, molybdenum (Mo) and/or molybdenum alloy (Mo-alloy) may be used for the first metal layer 143.

The second metal layer 142 functions as a main electrode that is applied with an external driving voltage for driving the light emission device 40. The second metal layer 142 is formed of metal having a low resistance, such as aluminum (Al). However, the present invention is not limited to this configuration. For example, copper (Cu) or gold (Au) may be used for the second metal layer 142.

The third metal layer 143′ is formed on the second metal layer 142 to prevent the hillock phenomenon from occurring at the second metal layer 142 (or to protect the second metal layer 142 from the hillock phenomenon) during the high temperature thermal process. The third metal layer 143′ is formed of same (or substantially the same) metal as the first metal layer 143.

Also, when the first and third metal layers 143 and 143′ are respectively formed on bottom and top surfaces of the second metal layer 142, the thicknesses of the first and third metal layers 143 and 143′ become important factors for maintaining an electrical property of the metal by minimizing (or reducing) diffusion between different metal layers.

When the thickness of the first metal layer is same (or substantially the same) as that of the third metal layer, the first and third metal layers contact the opposite surfaces of the second metal layer formed of aluminum during the high temperature thermal process. Here, a degree of the diffusion of the first metal layer formed under the bottom surface of the second metal layer is greater than a degree of the diffusion of the third metal layer formed above the second metal layer. As a result, even when the hillock phenomenon occurs at the second metal layer, the deformation of the top surface of the second metal layer is still greater than that of the bottom surface of the second metal layer.

The effect of the present exemplary embodiments through the configuration of the thicknesses of the first and third metal layers will be explained in more detail with reference to Exemplary Examples and Comparative Examples below. The following Exemplary Examples may, however, be embodied in many different forms and should not be construed as being limited to the embodiments set forth herein.

In Exemplary Examples and Comparative Examples, a resistance variation before and after a sintering process of the cathode electrode 14 was measured in a state where a thickness of the second metal layer 142 was fixed but thicknesses of the first and third metal layers 143 and 143′ were varied.

### EXEMPLARY EXAMPLE 1

The third and first metal layers were respectively formed on top and bottom surfaces of the second metal layer. The second metal layer was formed to have a thickness T2 of 1000 Å.

### EXEMPLARY EXAMPLE 2

The third and first metal layers were respectively formed on top and bottom surfaces of the second metal layer. The second metal layer was formed to have a thickness T2 of 2000 Å.

### EXEMPLARY EXAMPLE 3

The third and first metal layers were respectively formed on top and bottom surfaces of the second metal layer. The second metal layer was formed to have a thickness T2 of 2000 Å.

In Exemplary Examples 1, 2, and 3, a thickness T3 of the third metal layer and a thickness T1 of the first metal layer were varied but the thickness of the third metal layer was equal to or greater than the thickness of the first metal layer.

### COMPARATIVE EXAMPLE 1

The third and first metal layers were respectively formed on top and bottom surfaces of the second metal layer. The second metal layer was formed to have a thickness T2 of 1000 Å.

### COMPARATIVE EXAMPLE 2

The third and first metal layers were respectively formed on top and bottom surfaces of the second metal layer. The second metal layer was formed to have a thickness T2 of 2000 Å.

### COMPARATIVE EXAMPLE 3

The third and first metal layers were respectively formed on top and bottom surfaces of the second metal layer. The second metal layer was formed to have a thickness T2 of 2000 Å.

In Comparative Examples 1, 2, and 3, a thickness T3 of the third metal layer and a thickness T1 of the first metal layer were varied but the first metal layer was thicker than the third metal layer.

After forming each of the cathode electrodes having a multi-layer structure, the electron emission regions were sintered at 420° C. for 20 minutes and a sealing process for sealing the cathode and anode electrodes was preformed at 420° C. for 20 minutes. A resistance R1 of the cathode electrode before the sintering and sealing processes were performed was measured. Also, a resistance R2 of the cathode electrode after the sintering and sealing processes were performed was measured. The measurement results are shown in Tables 1 through 3.

TABLE 1

| | T2 | T3/T1 | R2/R1 |
|---|---|---|---|
| Exemplary Example 1-1 | 1000 Å | 1.0 | 1.00 |
| Exemplary Example 1-2 | | 1.2 | 0.98 |
| Exemplary Example 1-3 | | 1.5 | 0.96 |
| Exemplary Example 1-4 | | 1.8 | 0.95 |
| Exemplary Example 1-5 | | 2.0 | 0.94 |
| Comparative Example 1-1 | | 0.3 | 6.82 |
| Comparative Example 1-2 | | 0.5 | 4.46 |
| Comparative Example 1-3 | | 0.7 | 2.45 |

TABLE 2

| | T2 | T3/T1 | R2/R1 |
|---|---|---|---|
| Exemplary Example 2-1 | 2000 Å | 1.0 | 0.98 |
| Exemplary Example 2-2 | | 1.2 | 0.94 |
| Exemplary Example 2-3 | | 1.5 | 0.91 |
| Exemplary Example 2-4 | | 1.8 | 0.88 |
| Exemplary Example 2-5 | | 2.0 | 0.87 |
| Comparative Example 2-1 | | 0.3 | 4.97 |
| Comparative Example 2-2 | | 0.5 | 2.93 |
| Comparative Example 2-3 | | 0.7 | 1.85 |

TABLE 3

| | T2 | T3/T1 | R2/R1 |
|---|---|---|---|
| Exemplary Example 3-1 | 3000 Å | 1.0 | 0.94 |
| Exemplary Example 3-2 | | 1.2 | 0.85 |
| Exemplary Example 3-3 | | 1.5 | 0.81 |
| Exemplary Example 3-4 | | 1.8 | 0.79 |
| Exemplary Example 3-5 | | 2.0 | 0.78 |
| Comparative Example 3-1 | | 0.3 | 3.82 |
| Comparative Example 3-2 | | 0.5 | 2.29 |
| Comparative Example 3-3 | | 0.7 | 1.56 |

Referring to Table 1, in Examples 1-1 through 1-5, the thickness T2 of the second metal layer 142 was 1,000 Å and the third metal layer 143′ was thicker than the first metal layer 143. When thickness ratios (T3/T1) of Examples 1-1 through 1-5 were respectively 1.0, 1.2, 1.5, 1.8, and 2.0, the resistance ratios (R2/R1) of the resistance R2 of the cathode electrode after the sintering and sealing processes were preformed to the resistance R1 of the cathode electrode before the sintering and sealing processes were performed were respectively 1.0, 0.98, 0.96, 0.95, and 0.94. That is, in Examples 1-1 through 1-5, the ratios (R2/R1) of the resistance R2 after the sintering and sealing processes were preformed to the resistance R1 before the sintering and sealing processes were performed were 1 or less. Namely, the resistance R2 after the sintering and sealing processes were performed was substantially (or almost) identical to the resistance R1 before the sintering and sealing processes were performed.

In Comparative Examples 1-1 through 1-3, the first metal layer was thicker than the third metal layer. When thickness ratios (T3/T1) were respectively 0.3, 0.5, and 0.7, the resistance ratios (R2/R1) were respectively 6.82, 4.46, and 2.45. That is, after the sintering and sealing processes were performed, the resistance of the cathode electrode increased significantly.

Referring to Tables 2 and 3, like the results shown in Table 1, when the third metal layer 143′ was thicker than the first metal layer 143, the resistances of the cathode electrode after and before the sealing and sintering processes were performed were substantially (or almost) identical to each other.

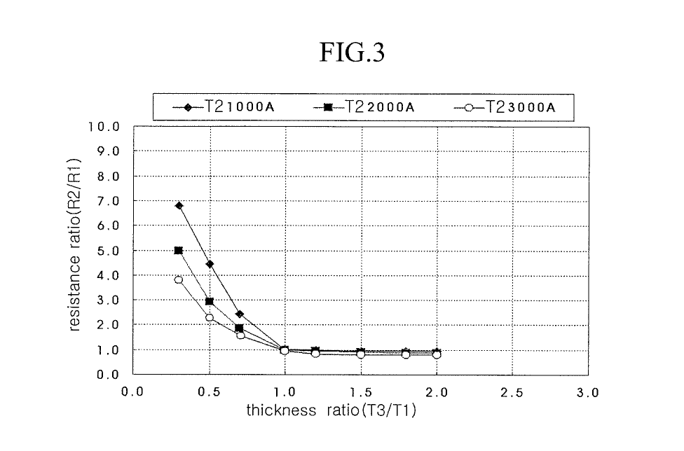

FIG. 3 is a graph illustrating results of the Examples and Comparative Examples.

As shown in FIG. 3, when the sub-metal layers are located on the top and bottom surfaces of the second metal layer 142, the sub-metal layer (the third metal layer 143′) formed on the top surface of the second metal layer 142 may be thicker than the sub-metal layer (the first metal layer 143). Here, a ratio (T3/T1) of the thickness T3 of the third metal layer 143′ to the thickness T1 of the first metal layer 143 may be 1 or more.

Also, in the present exemplary embodiments, although the cathode electrode is formed in a multi-layer structure, the present invention is not limited to this configuration. In addition, the gate electrode, which is also a driving electrode for driving the light emission device, may be formed in a structure identical (or substantially identical) to that of the cathode electrode.

Further, although the ITO electrodes, which are the transparent electrodes, are described as being formed on the first substrate for the electron emission regions for backside emission (or rear light emission), the ITO electrodes are not necessarily required when the electron emission regions are formed on the first substrate.

Referring now back to FIGS. 1 and 2, a second insulation layer 22 and a focusing electrode 24 are successively formed on the gate electrodes 180. The second insulation layer 22 located under the focusing electrode 24 is formed on a surface (or an entire surface) of the first substrate 10 to cover the gate electrodes 18, thereby insulating the gate electrodes 18 from the focusing electrode 24.

The focusing electrode 24 is formed in a single layer having a size (that may be predetermined) on the second insulation layer 22.

Third openings 221 and fourth openings 241 are respectively formed in the second insulation layer 22 and the focusing electrode 24. The electrons emitted from the electron emission regions 20 pass through the corresponding first and second openings 161 and 181 and further pass through the corresponding third and fourth openings 221 and 241 for focusing, thereby forming electron beams.

In the present exemplary embodiment, the openings formed in the focusing electrode may correspond to the respective unit pixels to generally focus the electrons emitted from each of the unit pixels. However, the present invention is not limited to this configuration. For example, the openings formed in the focusing electrode may correspond to the respective electron emission regions to individually focus the electrons emitted from each of the electron emission regions.

Phosphor layers 26 (e.g., red, green, and blue phosphor layers 26R, 26G, 26B) are formed on an inner surface of the second substrate 12 facing the first substrate 10 and in such a manner that a space (which may be predetermined) is provided between adjacent pairs of the phosphor layers 26. A black layer 28 is formed between adjacent pairs of the phosphor layers 26 to enhance screen contrast. The phosphor layers 26 are arranged to correspond to the respective unit pixels defined on the first substrate 10.

An anode electrode 30 is formed on the phosphor layers 26 and the black layer 28, and is formed of a metal material such as aluminum (Al). The anode electrode 30 is an acceleration electrode that receives an external high voltage to maintain the phosphor layers 26 at a high electric potential state, and functions also to enhance luminance by reflecting visible light. That is, among the visible light emitted from the phosphor layers 26, the visible light that is emitted from the phosphor layers 26 toward the first substrate 10 is reflected by the anode electrode 30 toward the second substrate 12, thereby improving the luminance.

In some embodiments, the anode electrode 30 may be formed of a transparent conductive material such as indium tin oxide. In this case, the anode electrode is located between the second substrate and the phosphor layer. In other embodiments, the anode electrode 30 may be realized through a structure in which a transparent conductive layer and a metal layer are combined.

A plurality of spacers 32 are located between the first and second substrates 10 and 12 to resist atmospheric pressure applied to the vacuum vessel to thereby ensure that the gap between the first and second substrates 10 and 12 is uniformly maintained.

The spacers 32 are located on the focusing electrode 24 at the first substrate 10 and located at the second substrate 12 to correspond in location to the black layers 28 so as not to block the phosphor layers 26.

A driving process of the light emission device will be explained in more detail below.

The light emission device is driven by application of voltages (that may be predetermined) to the cathode electrodes 14, the gate electrodes 18, the focusing electrode 24, and the anode electrode 30.

For example, in one embodiment, the cathode electrodes 14 function as scan electrodes for receiving a scan driving voltage while the gate electrodes 18 function as data electrodes for receiving a data driving voltage. In another embodiment, the gate electrodes 18 function as scan electrodes for receiving a scan driving voltage while the cathode electrodes 14 function as data electrodes for receiving a data driving voltage.

Further, the focusing electrode 24 receives a negative direct current voltage ranging from 0V to several to tens volts, and the anode electrode 30 receives a positive direct current voltage ranging from several hundreds to several thousand volts that are suitable for the acceleration of electron beams.

As a result, electric fields are formed around the electron emission regions 24 at the pixels where a voltage difference between the cathode and gate electrodes 14 and 18 is equal to or greater than a threshold value so that electrons are emitted from the electron emission regions 20. The emitted electrons are focused to a center of a bundle of electron beams while passing through the second openings 241 of the focusing electrode 24 and attracted by the high voltage applied to the anode electrode 30 to thereby collide with and excite the phosphor layers 26 of the corresponding unit pixels, thereby realizing an image.

Although the light emission device structured as in the above is described by way of example as having the display function for itself, it is to be understood that the light emission device may also be utilized as a surface light source for a passive type display.

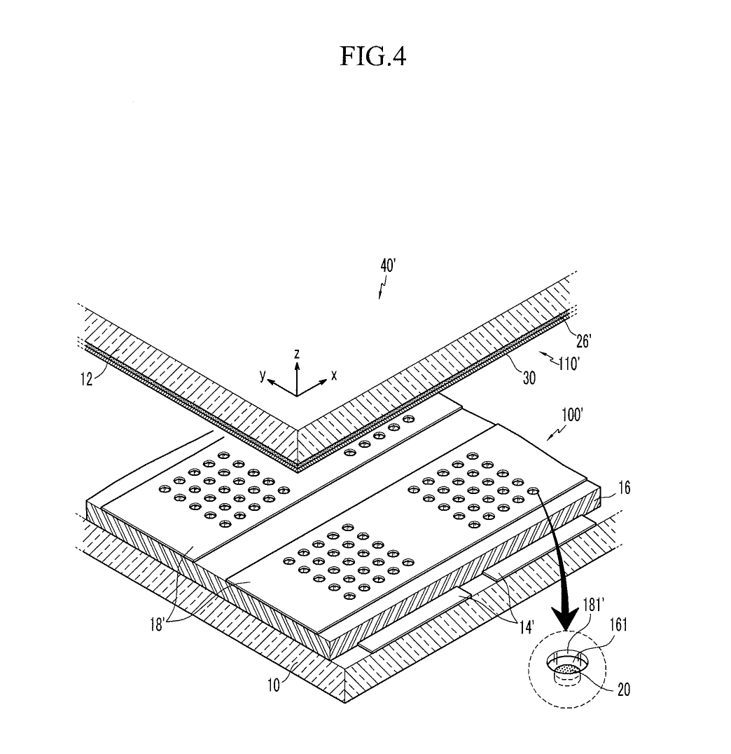

FIG. 4 is a partially exploded perspective view of a light emission device according to a second exemplary embodiment of the present invention. The light emission device of the second exemplary embodiment is used as a surface light source for a non self-emissive passive type display device.

Referring to FIG. 4, a light emission device 40′ according to a second exemplary embodiment has a basic structure that is substantially the same to that of the light emission device 40 of the first exemplary embodiment. However, in this embodiment, a size of the unit pixels formed by the crossing (or intersection) of cathode electrodes 14′ and gate electrodes 18′, a number of the electron emission regions 20 formed in each unit pixel, and a structure of a light emission unit 110′ are different from that of the first exemplary embodiment. Hence, only these differences of the second exemplary embodiment will be described in more detail below.

In the second exemplary embodiment, one of the crossing (or intersection) regions of the cathode and gate electrodes 14′ and 18′ may correspond to one pixel region of the light emission device 40′ or may correspond to two or more pixel regions of the light emission device 40′. In the latter case, the two or more of the cathode electrodes 14′ and/or the two or more of the gate electrodes 18′ corresponding to a single pixel region are electrically connected to thereby be applied with the same driving voltage.

The light emission unit 110′ includes a phosphor layer 26′ and an anode electrode 30, which are located on a surface of the second substrate 12.

The phosphor layer 26′ may be a white phosphor layer that emits white light. The phosphor layer 26′ may be formed on the entire active area of the second substrate 12, or may be formed in a pattern that may be predetermined such that one of the (white) phosphor layers 26′ corresponds in location to one of the pixel regions. The phosphor layer 26′ may also be realized by combinations of red, green, and blue phosphor layers, in which case the phosphor layers are formed in a pattern that may be predetermined in each of the pixel regions.

In FIG. 4, the white phosphor layer located on the entire active area of the second substrate 12 is illustrated by way of example.

The anode electrode 30 is formed of a metallic material such as aluminum covering the phosphor layer 26′. The anode electrode 30 is an acceleration electrode that receives a high voltage to maintain the phosphor layer 26′ at a high electric potential state to attract electron beams. The anode electrode 30 also functions to enhance luminance by reflecting visible light. That is, visible light that is emitted from the phosphor layer 26′ toward the first substrate 10 is reflected by the anode electrode 30 toward the second substrate 12.

Further, an arcing-preventing member having height that may be predetermined is formed on the anode electrode 30 in order to absorb a resulting arcing current when a high voltage is applied to the anode electrode 30.

When the cathode and gate electrodes 14′ and 18′ are applied with driving voltages that may be predetermined, electric fields are formed around the electron emission regions 20 at the unit pixels where a voltage difference between the cathode and gate electrodes 14′ and 18′ is equal to or higher than a threshold value so that electrons are emitted from the electron emission regions 20. The emitted electrons are attracted by the high voltage applied to the anode electrode 30 to thereby collide with corresponding areas of the phosphor layer 26′. As a result, the phosphor layer 26′ is excited and illuminated. Here, the illumination intensity of the phosphor layer 26′ corresponds to the electron beam emission amount for the corresponding pixels.

The gap between the first and second substrates 10 and 12 of the second exemplary embodiment may be greater than the gap between the first and second substrates 10 and 12 of the first exemplary embodiment, and the anode electrode 30 may be applied through anode leads with a high voltage of 10 kV or greater, e.g., a high voltage of between 10 and 15 kV. Since the first and second substrates 10 and 12 of the second exemplary embodiment are separated by a gap that may be greater than the gap between the first and second substrates 10 and 12 of the first exemplary embodiment, the spacers of the second exemplary embodiment located between the first and second substrates 10 and 12 may be greater than those of the first exemplary embodiment.

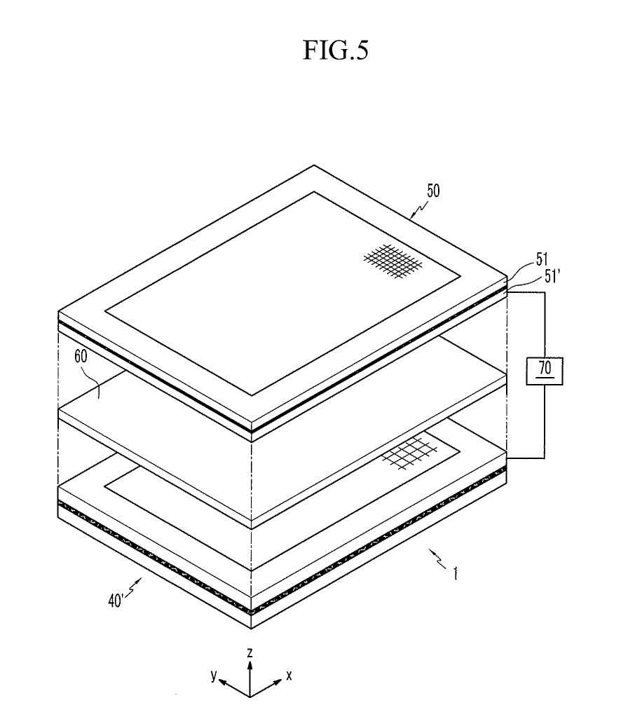

FIG. 5 is an exploded perspective view of a display device using the light emission device of the second exemplary embodiment as a surface light source according to an exemplary embodiment of the present invention.

Referring to FIG. 5, a display device 1 according to an exemplary embodiment of the present invention includes a display panel 50 forming a plurality of pixels in rows and columns, and a light emission device 40′ located in the rear of the display panel 50 for providing light to the display panel 50. In the following description, the light emission device 40′ will be referred to as a “backlight unit” for convenience purposes.

The display panel 50 may be a liquid crystal display panel, in which a liquid crystal layer is injected between a pair of substrates 51 and 51′, and a polarizer is attached to an outer surface of the substrates 51 and 51′. In one embodiment, any suitable liquid crystal panel may be used as the display panel 50.

An optical element (e.g., a diffusing plate or a diffusing sheet) 60 may be located between display panel 50 and the backlight unit 40′ as necessary.

In this embodiment, the backlight unit 40′ has a plurality of pixels arranged in columns and rows. The number of pixels formed by the backlight unit 40′ is less than the number of pixels of the display panel 50. That is, one of the pixels of the backlight unit 40′ corresponds to a plurality of the pixels of the display panel 50. Each of the pixels of the backlight unit 40′ is able to display a gray level corresponding to the highest gray level of the corresponding pixels of the display panel 50. The backlight unit 40′ is able to display gray levels in gray scale ranging from 2 to 8 bits for each of the pixels thereof.

For purposes of convenience of description, the pixels of the display panel 50 are referred to as “first pixels”, the pixels of the backlight unit 40′ are referred to as “second pixels”, and the first pixels corresponding to one of the second pixels is referred to as a “first pixel group”.

A signal controller 70 for controlling the display panel 50 detects a highest gray level of the first pixels of the first pixel group, determines a gray level required for light illumination of the second pixels according to the detected gray level, converts this detected gray level into digital data, and generates a drive signal for the backlight unit 40′ using this digital data. Accordingly, the second pixels of the backlight unit 40′ are synchronized with the corresponding first pixel groups when the first pixel groups display images to thereby perform light illumination at gray levels that may be predetermined.

For purposes of convenience of description, the “row” direction may be referred to as a horizontal direction (x-axis direction) of a screen realized by the display panel 50, and the “column” direction may be referred to as a vertical direction (y-axis direction) of the screen realized by the display panel 50.

The display panel 50 may have 240 or more pixels in each of rows and in each of columns, and the backlight unit 40′ may have from 2 to 99 pixels in each of rows and in each of columns. If the number of the pixels of the backlight unit 40′ in each of the rows and in each of columns exceeds 99, driving of the backlight unit 40′ becomes complicated and costs associated with the manufacture of the drive circuitry thereof are increased.

The backlight unit 40′ is a self-emissive display panel having a resolution in the range from 2×2 to 99×99, and the emission intensity of the pixels may be independently controlled such that light of a suitable intensity may be supplied to the pixels of the display panel 50 corresponding to each of the pixels of the backlight unit 40′. Accordingly, the display 50 of this embodiment is able to increase a dynamic contrast ratio of the screen to thereby realize a sharper picture quality.

In a light emission device according to exemplary embodiments of the present invention, the driving electrode is formed in a multi-layer structure having a main electrode (e.g., the second metal layer 142) and sub-electrodes (e.g., the first and third metal layers 143 and 143′) and thicknesses of the sub-electrodes are specifically configured to thereby suppress the hillock phenomenon of the main electrode and a chemical reaction between different electrodes during the high temperature thermal process.

Accordingly, a resistance of the driving electrodes (e.g., cathode electrodes) does not increase even after the post processes (e.g., sintering and sealing processes) are performed.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electron emission device, the device comprising:
a substrate;
a plurality of driving electrodes on the substrate; and
a plurality of electron emission regions electrically coupled to the driving electrodes,
wherein each of the driving electrodes comprises a first metal layer, a second metal layer, and a third metal layer, which are successively layered, and
wherein a following condition is satisfied:
T3/T1≧1.0,
where T1 is a thickness of the first metal layer and T3 is a thickness of the third metal layer.

2. The device of claim 1, wherein the first metal layer comprises a material substantially identical to that of the third metal layer.

3. The device of claim 1, wherein the second metal layer comprises a material selected from the group consisting of aluminum, copper, gold, and combinations thereof.

4. The device of claim 1, wherein the first metal layer comprises a material selected from the group consisting chrome, molybdenum, molybdenum alloy, and combinations thereof.

5. The device of claim 1, wherein the driving electrodes comprises electrodes selected from the group consisting of cathode electrodes, gate electrodes, and combinations thereof.

6. The device of claim 5, further comprising a focusing electrode located above the cathode and gate electrodes and insulated from the cathode and gate electrodes.

7. A light emission device, the device comprising:
a first substrate;
a second substrate opposing the first substrate;
an electron emission unit on the first substrate; and
a light emission unit on the second substrate,
wherein the electron emission unit comprises:
a plurality of driving electrodes on the first substrate; and
each of the driving electrodes comprises a first metal layer, a second metal layer, and a third metal layer, which are successively layered, and
wherein a following condition is satisfied:
T3/T1≧1.0,
where T1 is a thickness of the first metal layer and T3 is a thickness of the third metal layer.

8. The device of claim 7, wherein the first metal layer comprises a material substantially identical to that of the third metal layer.

9. The device of claim 7, wherein the second metal layer comprises a material selected from the group consisting of aluminum, copper, gold, and combinations thereof.

10. The device of claim 7, wherein the first metal layer comprises a material selected from the group consisting chrome, molybdenum, molybdenum alloy, and combinations thereof.

11. The device of claim 7, wherein the driving electrodes comprise electrodes selected from the group consisting of cathode electrodes, gate electrodes, and combinations thereof.

12. A display device comprising:
a display panel for displaying an image; and
a light emission device for providing light to the display panel,
wherein the light emission device comprises:
a first substrate;
a second substrate opposing the first substrate;
an electron emission unit on the first substrate; and
a light emission unit on the second substrate,
wherein the electron emission unit comprises:
a plurality of driving electrodes on the first substrate; and
each of the driving electrodes comprises a first metal layer, a second metal layer, and a third metal layer, which are successively layered, and
wherein a following condition is satisfied:
T3/T1≧1.0,
where T1 is a thickness of the first metal layer and T3 is a thickness of the third metal layer.

13. The device of claim 12, wherein the first metal layer comprises a material substantially identical to that of the third metal layer.

14. The device of claim 12, wherein the second metal layer comprises a material selected from the group consisting of aluminum, copper, gold, and combinations thereof.

15. The device of claim 12, wherein the first metal layer comprises a material selected from the group consisting chrome, molybdenum, molybdenum alloy, and combinations thereof.

16. The device of claim 12, wherein the display panel comprises a liquid crystal panel.

17. The device of claim 12, wherein the display panel has a plurality of first pixels, wherein the light emission device has a plurality of second pixels, wherein the second pixels are less in number than the first pixels, and wherein an intensity of the light emission of each of the second pixels is independently controlled.

18. The device of claim 12, wherein the second metal layer is configured to be applied with an external driving voltage for driving the light emission device.
